(19) United States
(12) Patent Application Publication
(10) Pub. No.: US 2010/0124445 A1
(43) Pub. Date: May 20, 2010

(54) Transfer Target Object Separation Apparatus, Transferring Apparatus, Image Formation Apparatus, and Transfer Target Object Separation Control Method

(75) Inventors: Shinichi TANAKA, Shiojiri-shi, (JP); Kuniaki TANAKA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/615,988

(22) Filed: Nov. 10, 2009

(30) Foreign Application Priority Data
Nov. 17, 2008 (JP) 2008-293425

(51) Int. Cl. G03G 15/16

(52) U.S. Cl. 399/308

(57) ABSTRACT

A transfer target object separation apparatus includes: a transfer target object movement member that moves a transfer target object while in contact with a first surface of the transfer target object; and a transfer target object separation suction section that sucks a second surface of the transfer target object opposite the first surface to separate the transfer target object from the transfer target object movement member. The transfer target object separation suction section includes a first cylindrical rotation member that has a suction inlet, and a second cylindrical rotation member that is fitted on the first cylindrical rotation member and has a hole through which the second surface of the transfer target object is sucked.

### CROSS-REFERENCE TO RELATED APPLICATIONS

This application claims the benefit of priority under 35 USC 119 of Japanese application no. 2008-293425, filed on Nov. 17, 2008, which is incorporated herein by reference.

### BACKGROUND

1. Technical Field

The present invention relates to a transfer target object separation apparatus that separates, from a transfer target object movement member, a transfer target object onto which an image developed with a liquid developer (e.g., liquid toner) has been transferred in an electro-photographic image formation apparatus that uses the liquid developer, for example, a copier, a facsimile, a printer, and the like. In addition, the invention relates to a transferring apparatus that transfers a liquid-developer image onto a transfer target object, an image formation apparatus, and a transfer target object separation control method.

2. Related Art

In a typical operation of an image formation apparatus that uses a liquid developer (e.g., liquid toner), a transferring device transfers a liquid-developer image onto a transfer target object. The transfer target object is transported while in contact with a transfer medium of the transferring device under pressure as the transfer medium moves. In addition, the transfer target object onto which the liquid-developer image has been transferred is transported while in contact with a fixation member of a transferring device under pressure as the transfer medium moves. By this means, the liquid-developer image is fixed on the transfer target object.

In the image transfer operation and the fixation operation described above, a transfer surface of the transfer target object, which is a surface closer to the liquid-developer image, is pressed against and thus brought into contact with a transfer target object movement member such as the transfer medium, the fixation member, and the like. When the transfer surface of the transfer target object is in contact with the transfer target object movement member under pressure, due to the nature of liquid developer, the transfer target object is apt to stick to the transfer target object movement member. For this reason, it is difficult to separate the transfer target object onto which the liquid-developer image has been transferred from the transfer target object movement member. In an effort to provide a solution to such a problem, an image formation apparatus that is provided with a transfer target object separation device has been proposed as disclosed in, for example, Japanese Patent No. 3,128,067. The transfer target object separation device disclosed in Japanese Patent No. 3,128,067 blows air toward the front edge of a transfer target object that is transported as a transfer target object movement member moves. Utilizing the air, the proposed transfer target object separation device forcibly separates the front edge part of the transfer target object from the transfer target object movement member. The air blown by the transfer target object separation device of Japanese Patent No. 3,128,067 enters a gap between the front edge of the transfer target object and the transfer target object movement member. By this means, if successful, the front edge part of the transfer target object is separated from the transfer target object movement member.

However, the transfer target object separation device of Japanese Patent No. 3,128,067 just blows air toward the front edge of a transfer target object during image formation operation. Therefore, it is difficult to separate the transfer target object from the transfer target object movement member without fail. In addition, air is blown onto the transfer surface of a transfer target object. For this reason, the air could affect a liquid-developer image transferred to the transfer target object.

### SUMMARY

An advantage of some aspects of the invention is to provide a transfer target object separation apparatus that separates a transfer target object from a transfer target object movement member with improved reliability without affecting a liquid-developer image transferred to the transfer target object. In addition, the invention provides, as an advantage of some aspects thereof, a transferring apparatus, an image formation apparatus, and a transfer target object separation control method.

In order to address the above-identified problems without any limitation thereto, in a transfer target object separation apparatus, a transferring apparatus, an image formation apparatus, and a transfer target object separation control method according to an aspect of the invention, a second cylindrical rotation member that has holes sucks a second surface of a transfer target object after the transferring of an image to the transfer target object through the holes. The second surface of the transfer target object is opposite a first surface thereof. The first surface of the transfer target object is a transfer surface onto which the image is transferred. Since the second cylindrical rotation member sucks the transfer target object, it is possible to separate the transfer target object from a transfer target object movement member without fail. In this sucking operation, the second cylindrical rotation member sucks the second surface of the transfer target object that is opposite the transfer surface. Therefore, it is possible to avoid an image transferred to the transfer target object from being affected by the sucking operation.

In addition, since holes are formed throughout the entire circumferential surface of the second cylindrical rotation member, it is possible to hold a transfer target object by suction continuously during the sucking operation even when the second cylindrical rotation member rotates in synchronization with the movement of the transfer target object and the transfer target object movement member. Moreover, since air is continuously taken in through a suction inlet of a first cylindrical rotation member that faces a transfer target object during the sucking operation and has a small capacity, it is possible to ensure that a suction force applied to the transfer target object is large enough to separate the transfer target object from the transfer target object movement member. Therefore, the capacity of a vacuuming section that sucks air can be reduced. Furthermore, since a transfer target object is not sucked when the hole of the second cylindrical rotation member is displaced from the position of the suction inlet, it is possible to move the transfer target object onto the next transport position smoothly.

In addition, since the suction inlet of the first cylindrical rotation member through which the front edge part of a transfer target object is sucked also rotates when the second cylindrical rotation member rotates, it is possible to guide the front edge part of the transfer target object to the position of a transfer target object belt transportation device while securely holding the front edge part of the transfer target object by suction. Since the front edge part of the transfer target object is reliably sucked through the rotating suction inlet of the first cylindrical rotation member, it is possible to make the circumferential width of the suction inlet of the first cylindrical rotation member further smaller. By this means, the pressure loss of a transfer target object separation suction section can be reduced effectively, which makes it possible to reduce the size of the vacuuming section and achieve cost reduction. Though a minor gap exists between the outer circumferential surface of the first cylindrical rotation member and the inner circumferential surface of the second cylindrical rotation member or between the outer circumferential surface of the suction inlet and the inner circumferential surface of the second cylindrical rotation member, the gap does not have any significant influence on the pressure loss.

### BRIEF DESCRIPTION OF THE DRAWINGS

The invention will be described with reference to the accompanying drawings, wherein like numbers reference like elements.

FIG. 1A is a diagram that partially illustrates an image formation apparatus with a transfer target object separation device according to an exemplary embodiment of the invention.

FIG. 1B is an enlarged view of part IB of FIG. 1A.

FIG. 2 is an enlarged transverse sectional view of a suction wheel according to an exemplary embodiment of the invention.

FIG. 3A is an enlarged transverse sectional view of a nozzle of the suction wheel according to an exemplary embodiment of the invention.

FIG. 3B is a plan view of the nozzle according to an exemplary embodiment of the invention.

FIG. 4A is a partial plan view of the image formation apparatus according to an exemplary embodiment of the invention.

FIG. 4B is a partial sectional view of the image formation apparatus according to an exemplary embodiment of the invention.

FIG. 5 is a partial perspective view of the transfer target object separation device according to an exemplary embodiment of the invention.

FIG. 6 is a diagram that schematically illustrates rotation of the nozzle according to an exemplary embodiment of the invention.

FIG. 7 is a partial perspective view that schematically illustrates the connection of the transfer target object separation device to a vacuum pump according to an exemplary embodiment of the invention.

FIG. 8A is a diagram that schematically illustrates the sucking operation of the nozzle according to an exemplary embodiment of the invention.

FIG. 8B is a diagram that schematically illustrates the sucking operation of the nozzle according to an exemplary embodiment of the invention.

FIG. 8C is a diagram that schematically illustrates the sucking operation of the nozzle according to an exemplary embodiment of the invention.

### DESCRIPTION OF EXEMPLARY EMBODIMENTS

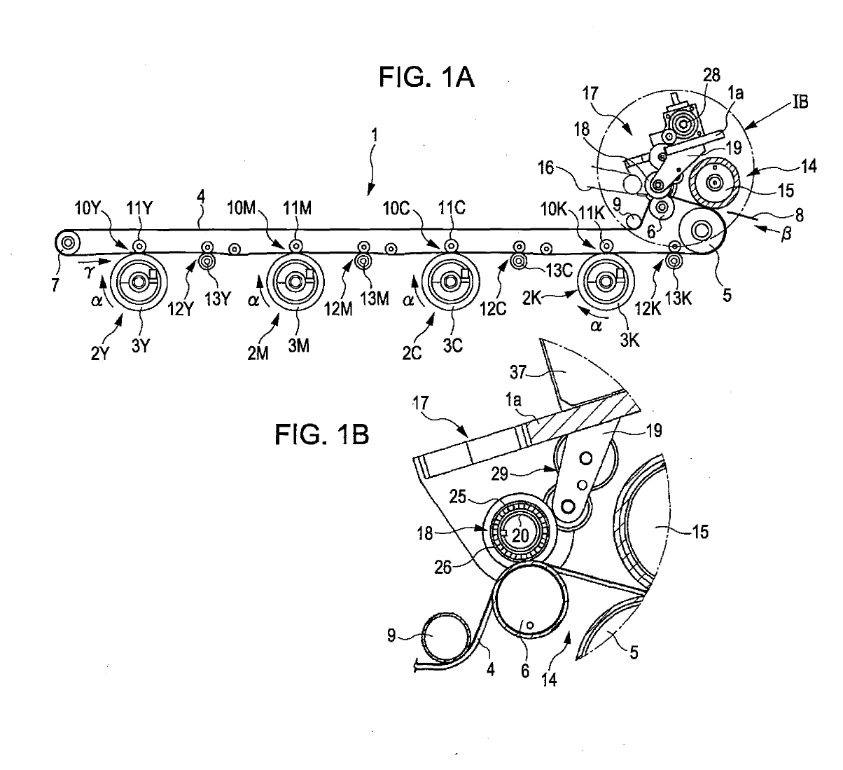

With reference to the accompanying drawings, the best mode for carrying out the present invention will now be explained in detail. FIG. 1A is a diagram of an image formation apparatus with a transfer target object separation device according to an exemplary embodiment of the invention. FIG. 1B is an enlarged view of part IB of FIG. 1A. As illustrated in FIG. 1A, an image formation apparatus 1 according to the present embodiment of the invention is provided with image formation units 2Y, 2M, 2C, and 2K that use a yellow (Y) liquid developer, a magenta (M) liquid developer, a cyan (C) liquid developer, and a black (K) liquid developer, respectively. Image formation units 2Y, 2M, 2C, and 2K are arranged in tandem. In the tandem image formation units 2Y, 2M, 2C, and 2K, the reference designator 2Y denotes a yellow image formation unit. The reference designator 2M denotes a magenta image formation unit. The reference designator 2C denotes a cyan image formation unit. The reference designator 2K denotes a black image formation unit. In the following description, reference letters Y, M, C, and K are attached to reference numerals of other components as suffixes to indicate respective colors in the same manner as above.

The image formation units 2Y, 2M, 2C, and 2K are provided with photosensitive members 3Y, 3M, 3C, and 3K, respectively (collectively referred to as the photosensitive member 3). The photosensitive member 3 is an example of a latent image carrier according to an aspect of the invention. In the illustrated example of FIG. 1A, each of the photosensitive members 3Y, 3M, 3C, and 3K is a photosensitive drum. Each of the photosensitive members 3Y, 3M, 3C, and 3K may be an endless belt.

The photosensitive members 3Y, 3M, 3C, and 3K rotate in a clockwise direction indicated by an arrow α in FIG. 1A during operation. As in the configuration of a conventional and well-known image formation apparatus that uses liquid developers, each of the image formation units 2Y, 2M, 2C, and 2K is provided with an electrification member, a light exposure device, a liquid developing device, a photosensitive member squeezing device, a diselectrification device, and a photosensitive member cleaning device that are provided around the corresponding one of the photosensitive members 3Y, 3M, 3C, and 3K. These components are not illustrated in the drawing. The electrification member, the light exposure device, the liquid developing device, the photosensitive member squeezing device, the diselectrification device, and the photosensitive member cleaning device are arranged in the order of appearance herein around each of the photosensitive members 3Y, 3M, 3C, and 3K when viewed in the direction of the rotation thereof. An electrostatic latent image of the corresponding color is formed on each of the photosensitive members 3Y, 3M, 3C, and 3K. Then, the electrostatic latent image of each color is developed by means of a liquid developer of the corresponding color. In this way, a toner image is formed on each of the photosensitive members 3Y, 3M, 3C, and 3K.

As illustrated in FIG. 1A, the image formation apparatus 1 is provided with an intermediary image transfer belt 4, which is an endless belt. The intermediary image transfer belt 4 is an example of a transfer medium according to an aspect of the invention. The transfer medium may be embodied as an image transfer roller. In the following description, the intermediary image transfer belt 4 is taken as an example of the transfer medium. The intermediary image transfer belt 4 is stretched between a belt driving roller 5 and a driven roller 7. Another driven roller 6 that is also in contact with the intermediary image transfer belt 4 is provided as one of a pair of driven rollers. The power of a driving motor, which is not illustrated in the drawing, is transmitted to the belt driving roller 5. The belt driving roller 5 and one of the pair of slave rollers, the driven roller 6, are provided in the proximity of each other with a predetermined gap therebetween along a transfer target object movement direction β. A transfer target object (i.e., transfer material) 8 such as a sheet of printing paper or the like that is fed to a secondary image transfer device 14 is transported in the transfer target object movement direction β, which is indicated by an arrow in the drawing. The secondary image transfer device 14 is an example of a second transferring section, which will be explained later. The belt driving roller 5 and the other driven roller 7 are provided with a distance therebetween in the direction of the tandem arrangement of the photosensitive members 3Y, 3M, 3C, and 3K. A tension roller 9 applies a predetermined tension to the intermediary image transfer belt 4. The intermediary image transfer belt 4 can turn in a counterclockwise direction indicated by an arrow γ in FIG. 1A when the belt driving roller 5 rotates.

The yellow image formation unit 2Y, the magenta image formation unit 2M, the cyan image formation unit 2C, and the black image formation unit 2K are arrayed in the order of appearance herein when viewed in the direction of the rotation γ of the intermediary image transfer belt 4. That is, in the configuration of the image formation apparatus 1 illustrated in FIG. 1, the yellow image formation unit 2Y is provided as the leftmost image formation unit whereas the black image formation unit 2K is provided as the rightmost image formation unit. However, the order of the arrangement of the image formation units 2Y, 2M, 2C, and 2K is not limited to the illustrated example and may be modified arbitrarily.

Primary image transfer devices 10Y, 10M, 10C, and 10K (collectively referred to as the primary image transfer device 10) are provided at the periphery of the photosensitive members 3Y, 3M, 3C, and 3K, respectively. The primary image transfer device 10 is an example of a first transferring section according to an aspect of the invention. Each of the primary image transfer devices 10Y, 10M, 10C, and 10K is provided between the photosensitive member squeezing device and the diselectrification device, which are not shown in the drawing. The primary image transfer devices 10Y, 10M, 10C, and 10K are provided with primary image transfer backup rollers 11Y, 11M, 11C, and 11K, respectively. The backup rollers 11Y, 11M, 11C, and 11K apply a pressing force to the intermediary image transfer belt 4. Accordingly, the intermediary image transfer belt 4 is in contact with the photosensitive members 3Y, 3M, 3C, and 3K.

Each of the backup rollers 11Y, 11M, 11C, and 11K is charged with a polarity that is opposite to the electrification polarity of toner particles. As a result, a toner image that is formed on each of the photosensitive members 3Y, 3M, 3C, and 3K is transferred onto the intermediary image transfer belt 4. Each toner image is transferred onto the intermediary image transfer belt 4 as follows. A yellow (Y) toner image is transferred onto the intermediary image transfer belt 4 first. Next, a magenta (M) toner image is transferred onto the intermediary image transfer belt 4. The magenta toner image is laid over the yellow toner image for color superposition. Thereafter, a cyan (C) toner image is transferred onto the intermediary image transfer belt 4. The cyan toner image is laid over the superposed yellow-and-magenta toner image for color superposition. Subsequently, a black (K) toner image is transferred onto the intermediary image transfer belt 4. The black toner image is laid over the superposed toner image for further superposition. In this way, a full color toner image is formed on the intermediary image transfer belt 4.

Intermediary image transfer belt squeezing devices 12Y, 12M, 12C, and 12K are provided in the neighborhood of the primary image transfer devices 10Y, 10M, 10C, and 10K, respectively. The intermediary image transfer belt squeezing devices 12Y, 12M, 12C, and 12K are provided at downstream positions viewed from the primary image transfer devices 10Y, 10M, 10C, and 10K in the direction of the rotation γ of the intermediary image transfer belt 4. Accordingly, the intermediary image transfer belt squeezing devices 12Y, 12M, 12C, and 12K are arranged closer to the secondary image transfer device 14. The intermediary image transfer belt squeezing devices 12Y, 12M, 12C, and 12K are provided with intermediary image transfer belt squeezing rollers 13Y, 13M, 13C, and 13K, respectively. Each of the intermediary image transfer belt squeezing rollers 13Y, 13M, 13C, and 13K recovers carrier liquid of the corresponding color that remains on the intermediary image transfer belt 4.

The secondary image transfer device 14 is provided at the belt-driving-roller (5) side of the intermediary image transfer belt 4. The secondary image transfer device 14 is provided with an image transfer roller 15 that is indirectly in contact with the belt driving roller 5. In particular, the image transfer roller 15 is in contact with a part of the intermediary image transfer belt 4 that is curved along and in contact with the belt driving roller 5. The transfer target object 8 moves in the transfer target object movement direction β while being pinched at a transfer nip between the image transfer roller 15 and the intermediary image transfer belt 4. In the process of the movement of the transfer target object 8, a toner image (i.e., liquid-developer image) formed on the intermediary image transfer belt 4 is transferred onto the transfer target object 8. Having the functions explained above, the intermediary image transfer belt 4 is an example of a transfer target object movement member and a liquid developer image carrier according to an aspect of the invention.

The image formation apparatus 1 according to the present embodiment of the invention is provided with a transfer target object storage device and a pair of resist rollers, as in the configuration of a conventional image formation apparatus that performs secondary image transfer. The transfer target object 8 such as sheets of paper or the like is stored in the transfer target object storage device. The transfer target object storage device is provided at an upstream position viewed from the secondary image transfer device 14 along the direction of the transportation of the transfer target object 8. The pair of resist rollers feeds the transfer target object 8 picked up and transported from the transfer target object storage device to the secondary image transfer device 14. The transfer target object storage device and the pair of resist rollers are not illustrated in the drawing. In addition, the image formation apparatus 1 is provided with a fixation device and a transfer target object ejection tray at a downstream side viewed from the secondary image transfer device 14 along the direction of the transportation of the transfer target object 8. A transfer target object belt transportation device 16 is partially illustrated in FIG. 1A. The transfer target object belt transportation device 16 transports the transfer target object 8 from the secondary image transfer device 14 to the fixation device.

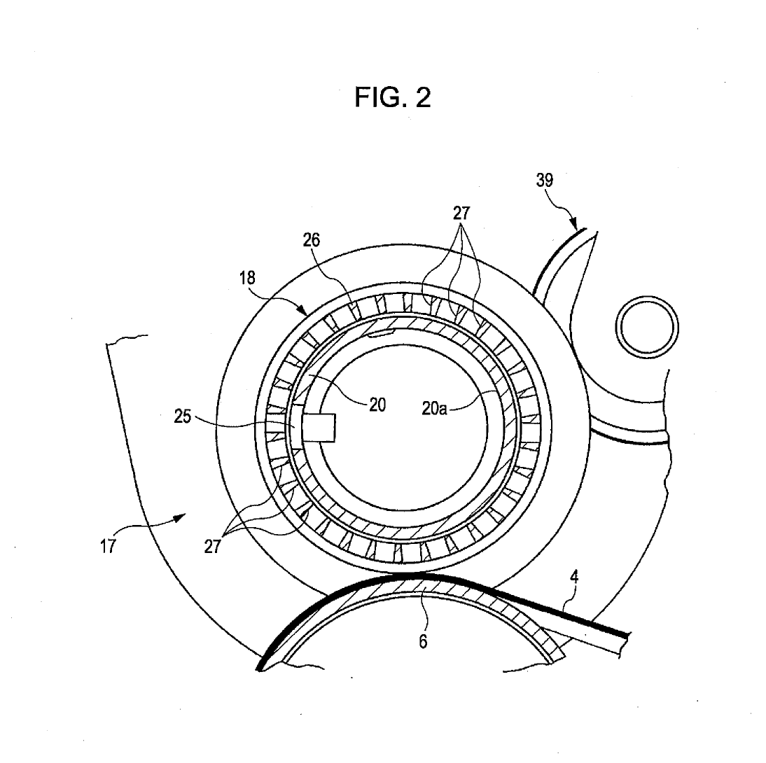

As illustrated in FIG. 1A, the secondary image transfer device 14 includes a transfer target object separation device 17 adjacent to the exit end of the transfer nip. As illustrated in FIGS. 1B, 2, and 3A in detail, the transfer target object separation device 17 is provided with a suction wheel 18 and a suction wheel support lever 19. The suction wheel 18, which is a vacuum wheel, is provided opposite to the driven roller 6. The suction wheel 18 can be brought into contact with the intermediary image transfer belt 4 and distanced from the intermediary image transfer belt 4. The suction wheel support lever 19 supports the suction wheel 18. The suction wheel support lever 19 is provided on a device body 1a. The suction wheel 18 and the suction wheel support lever 19 constitute an example of a transfer target object separation suction section according to an aspect of the invention.

The transfer target object separation device 17 further includes a cylindrical shaft 20 that is provided on the device body 1a as a rotatable shaft. The shaft 20 is an example of a first cylindrical rotation member according to an aspect of the invention. Partition walls 21 and 22 are provided on the shaft 20. A concavity 23 is formed between a part of the partition wall 21 and an opposite part of the partition wall 22. In addition, a suction port 24 is formed between another part of the partition wall 21 and an opposite part of the partition wall 22. The cylindrical shaft 20 has an inner hole 20a. The suction port 24 is formed as a communication port between the concavity 23 and the inner hole 20a of the shaft 20. Because of this structure, the concavity 23 is always in communication with the inner hole 20a of the shaft 20 through the suction port 24. The partition walls 21 and 22, which have the concavity 23 and the suction port 24, make up a nozzle 25. The nozzle 25 takes the outside air into the inner hole 20a of the shaft 20.

As illustrated in FIGS. 1B, 2, and 3A, the suction wheel 18 is provided on the shaft 20 rotatably. The suction wheel 18 is provided with a suction wheel outer cylinder 26, which is rotatable and has an elongated cylindrical shape. The suction wheel outer cylinder 26 is an example of a second cylindrical rotation member according to an aspect of the invention. There is a small clearance between the outer circumferential surface of the suction wheel outer cylinder 26 and the intermediary image transfer belt 4.

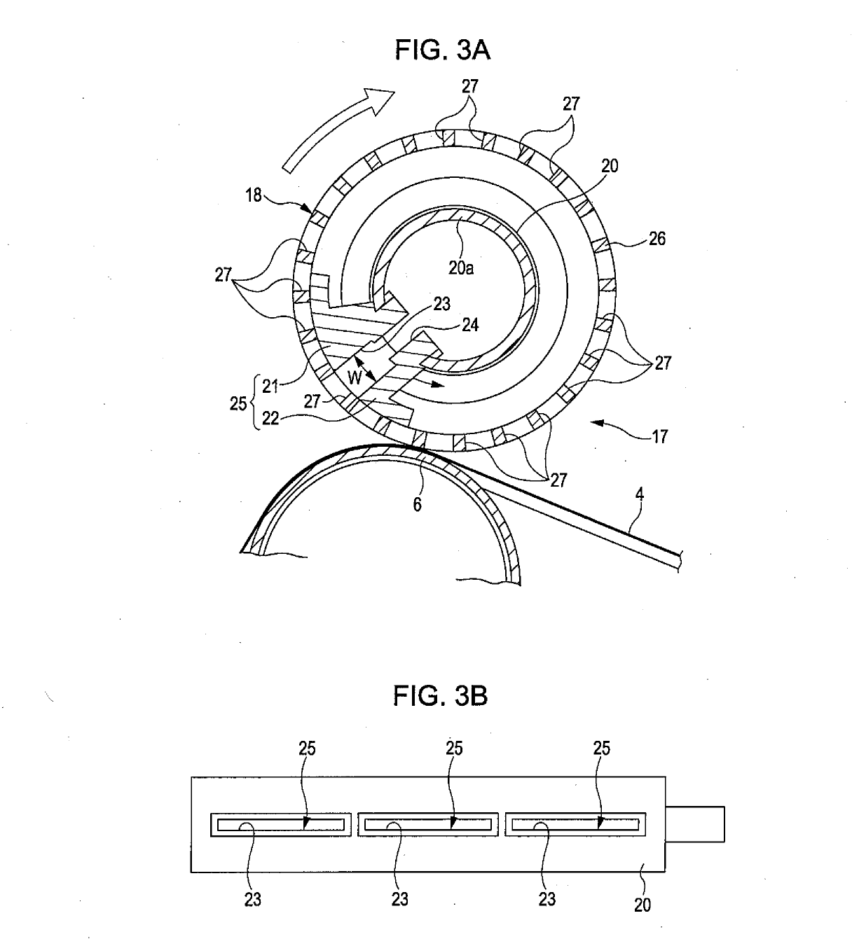

The nozzle 25 has an outer arc-shaped surface that has an outer diameter that is substantially the same as the inner diameter of the suction wheel outer cylinder 26. The circumferential width W of the concavity 23 of the nozzle 25 having an arc is small. In the illustrated structure, the circumferential width W of the concavity 23 is slightly larger than the diameter of each through hole 27 of the suction wheel outer cylinder 26. As illustrated in FIG. 3B, the nozzle 25 has an elongated shape and extends in the axial direction of the shaft 20. Three nozzles 25 are aligned in the axial direction of the shaft 20. The structure of the nozzle 25 (and the number of the nozzles 25) is not limited to the illustrated example. For example, a single nozzle 25 that is longer than the illustrated nozzle 25 may be provided. Or, the number of the nozzles 25 may be two, or four or more.

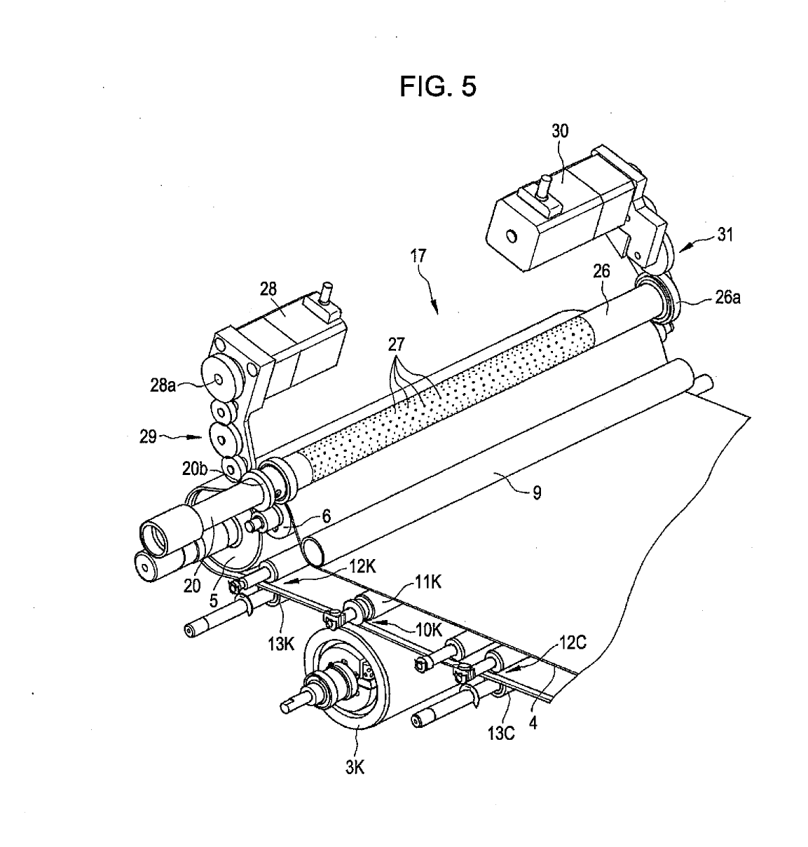

As illustrated in FIGS. 1, 4A, 4B, and 5, a shaft driving motor 28 provided on the device body 1a supplies power for rotating the shaft 20. The shaft driving motor 28 has a rotary shaft 28a that is indirectly connected to a gear 20b, which is provided on the shaft 20 as a circumferential gear. A power transmission gear mechanism 29 is provided between the rotary shaft 28a of the shaft driving motor 28 and the gear 20b of the shaft 20. When the shaft driving motor 28 rotates, the power of the shaft driving motor 28 is transmitted to the gear 20b through the power transmission gear mechanism 29 with speed reduction at the power transmission gear mechanism 29. The shaft 20 turns under the driving power of the shaft driving motor 28. The nozzle 25 turns together with the shaft 20.

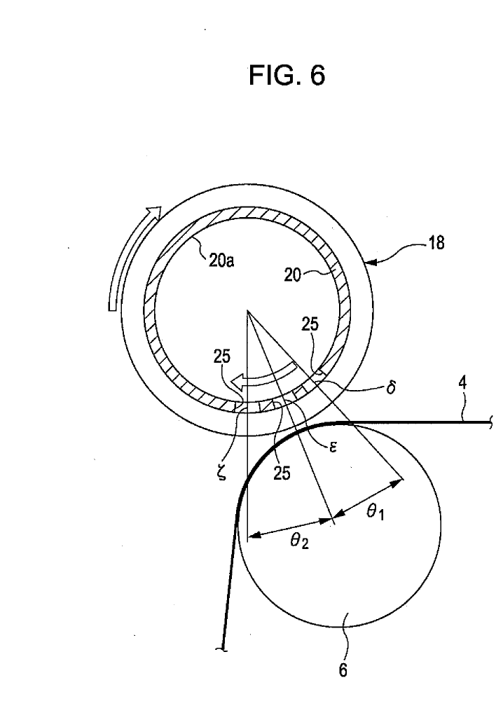

In the driving operation explained above, the shaft driving motor 28 causes the shaft 20 to turn in a reciprocating manner at a predetermined angle. For example, the shaft 20 reciprocates at an angle of approximately 30°. As a specific example, as illustrated in FIG. 6, the concavity 23 of the nozzle 25 turns in a reciprocating manner to change its position between a standby position δ, which is an initial position, a suction position ε, which is shifted from the standby position δ in the direction of rotation by a first predetermined angle θ₁ (e.g., approx. 15°), and a suction release position ζ, which is shifted from the suction position ε in the direction of rotation by a second predetermined angle θ₂ (e.g., approx. 15°).

An outer cylinder driving motor 30 provided on the device body 1a supplies power for rotating the suction wheel outer cylinder 26. The outer cylinder driving motor 30 has a rotary shaft (not shown) that is indirectly connected to a gear 26a, which is provided on the suction wheel outer cylinder 26 as a circumferential gear. A power transmission gear mechanism 31 is provided between the rotary shaft of the outer cylinder driving motor 30 and the gear 26a of the suction wheel outer cylinder 26. When the outer cylinder driving motor 30 rotates, the power of the outer cylinder driving motor 30 is transmitted to the gear 26a through the power transmission gear mechanism 31 with speed reduction at the power transmission gear mechanism 31. The suction wheel outer cylinder 26 turns under the driving power of the outer cylinder driving motor 30. Therefore, the shaft 20 and the suction wheel outer cylinder 26 can rotate independently of each other. The outer cylinder driving motor 30 drives the suction wheel outer cylinder 26 to turn the suction wheel outer cylinder 26 in a reciprocating manner at the process speed of the image formation apparatus 1 without any restriction on an angle of rotation. Specifically, the circumferential velocity of the suction wheel outer cylinder 26 is the same as the circumferential velocity of the intermediary image transfer belt 4.

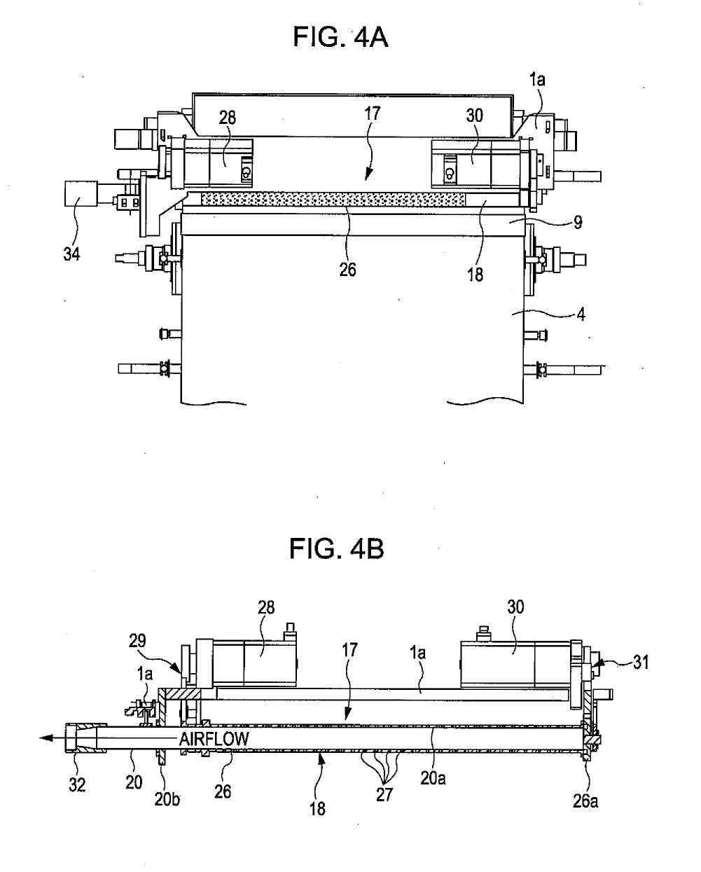

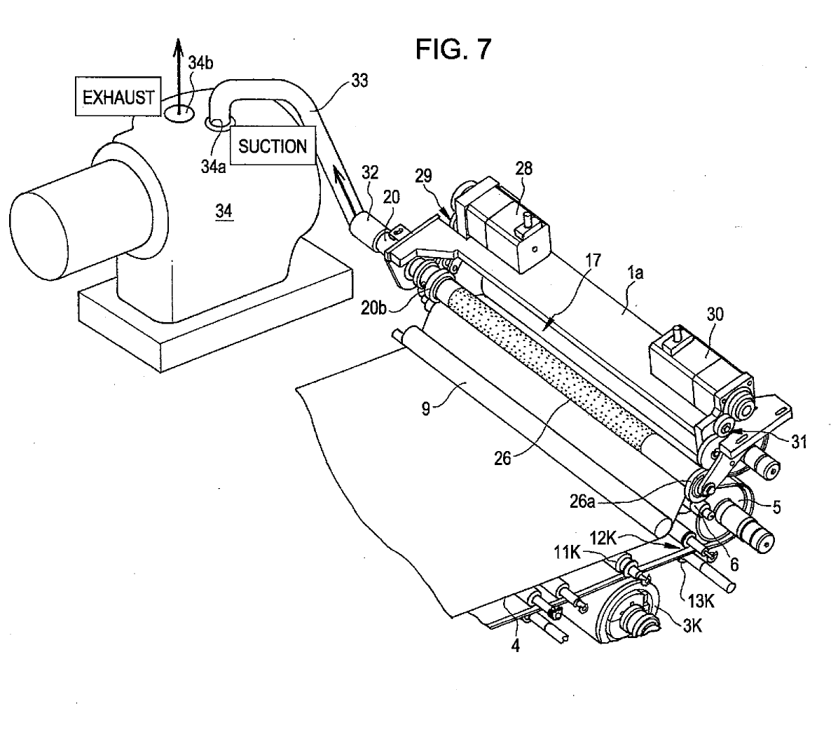

As illustrated in FIG. 4B, one end of the shaft 20 is closed whereas the other end thereof is open. As illustrated in FIG. 7, the open end of the shaft 20 is connected to a hose 33 via a coupling 32. The hose 33 is connected to an air intake port 34a of a vacuum pump 34. The vacuum pump 34 is an example of a vacuuming section according to an aspect of the invention. The vacuum pump 34 evacuates air from the inner hole 20a of the shaft 20 and then exhausts the vacuumed air from an air outlet port 34b. Since the coupling 32 is provided between the shaft 20 and the hose 33, the hose 33 does not get twisted when the shaft 20 turns. The coupling 32 enables the shaft 20 and the hose 33 to be securely connected to each other while keeping the connection airtight.

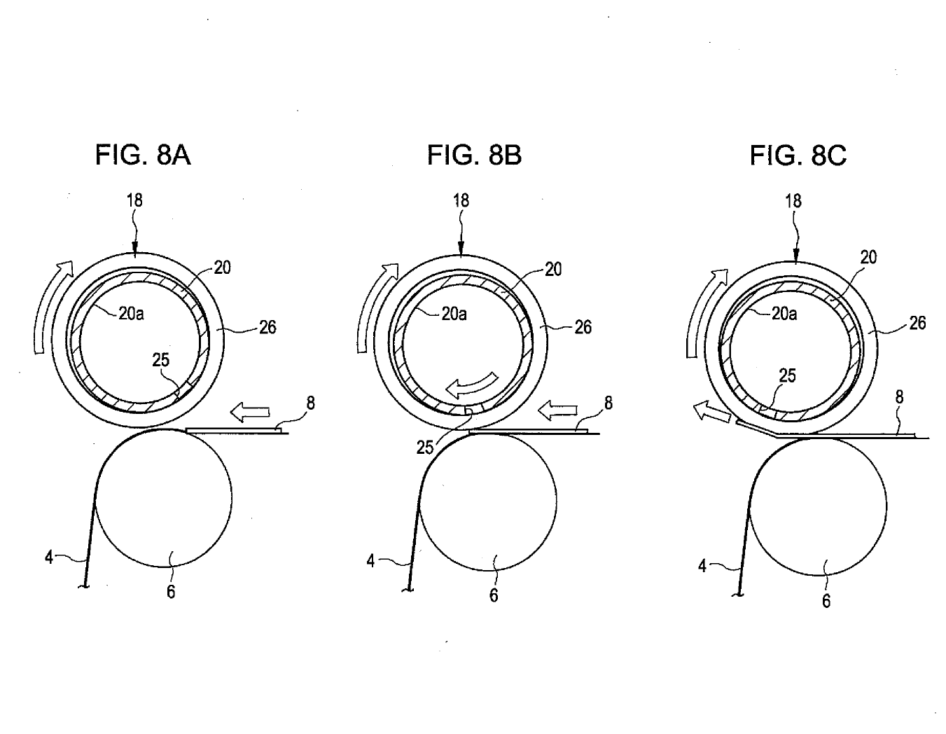

Next, the operation of the sucking of the front edge part of the transfer target object 8 by the nozzle 25 is explained below. The sucking operation described below is an example of a transfer target object separation control method according to an aspect of the invention. As illustrated in FIG. 8A, the transfer target object 8 is transported from the right to the left when the concavity 23 of the nozzle 25 is set at the standby position δ (a standby position step). Next, the shaft driving motor 28 starts to rotate when the front edge of the transfer target object 8 moving in the transport direction arrives at a predetermined position that is in front of a pinch position at which the transfer target object 8 will be pinched between the intermediary image transfer belt 4 and the suction wheel outer cylinder 26. Driven by the shaft driving motor 28, the shaft 20 starts to rotate together with the nozzle 25. At the same time, the outer cylinder driving motor 30 operates to turn the suction wheel outer cylinder 26 (a second cylindrical rotation member rotation step). During the operation explained above, slow-up control is performed to synchronize the rotation of the shaft 20, the nozzle 25, and the suction wheel outer cylinder 26 with the transport speed of the transfer target object 8.

As illustrated in FIG. 8B, the nozzle 25 arrives at the suction position ε when the front edge of the transfer target object 8 arrives at a separation start position after having been pinched between the intermediary image transfer belt 4 and the suction wheel outer cylinder 26 (a suction position step). The separation start position is a position at which the front edge of the transfer target object 8 starts to be separated from the intermediary image transfer belt 4. When the nozzle 25 arrives at the suction position ε, the nozzle 25 starts to suck the front edge part of the transfer target object 8 (a transfer target object suction step). The position at which the suction wheel outer cylinder 26 comes opposite to the intermediary image transfer belt 4, which is the position at which the suction wheel outer cylinder 26 and the intermediary image transfer belt 4 come closest to each other, is located slightly closer to the transfer target object belt transportation device 16 (which is the left side in FIG. 8B) in comparison with the position at which the intermediary image transfer belt 4 is in contact with the driven roller 6. For this reason, as explained above, the suction wheel 18 can suck the front edge part of the transfer target object 8 effectively.

Thereafter, the suction wheel outer cylinder 26 rotates while the suction wheel 18 continues to suck the front edge part of the transfer target object 8. The nozzle 25 also further rotates at the same speed as the rotation speed of the suction wheel outer cylinder 26 in overrun (a rotation step). Because of the overrun rotation of the nozzle 25, the suction wheel 18 can continue to securely hold the front edge part of the transfer target object 8 by suction. Then, when the nozzle 25 arrives at the suction release position ζ as illustrated in FIG. 8c, the rotation of the shaft 20 and the nozzle 25 is stopped (a first cylindrical rotation member rotation stop step). On the other hand, the rotation of the suction wheel outer cylinder 26 continues. As a result, since the front edge part of the transfer target object 8 is displaced from the position of the concavity 23 of the nozzle 25, the holding of the front edge part of the transfer target object 8 by suction is released. Accordingly, the rotation of the suction wheel outer cylinder 26 is stopped (a second cylindrical rotation member rotation stop step). As the transfer target object 8 continues to be transported, the front edge part of the transfer target object 8 comes off from the suction wheel 18. The transfer target object 8 that has come off from the suction wheel 18 is transported to the transfer target object belt transportation device 16 and sucked by the transfer target object belt transportation device 16. On the other hand, the shaft 20 and the nozzle 25 that stopped at the suction release position ζ are moved in the reverse rotation direction to be set at the standby position δ again.

The image formation apparatus 1 according to the present embodiment of the invention, which is provided with the transfer target object separation device 17 that has the structure explained above, offers the following advantages. The suction wheel outer cylinder 26 of the suction wheel 18 sucks a second surface of the transfer target object 8 after the transferring of an image to the transfer target object 8. The second surface of the transfer target object 8 is a surface that is opposite a first surface thereof. The first surface of the transfer target object 8 is a transfer surface onto which the image is transferred. Since the suction wheel outer cylinder 26 sucks the transfer target object 8, it is possible to separate the transfer target object 8 from the intermediary image transfer belt 4 without fail. In this sucking operation, the suction wheel outer cylinder 26 sucks the second surface of the transfer target object 8 that is the reverse side opposite the transfer surface. Therefore, it is possible to avoid a liquid-developer image transferred to the transfer target object 8 from being affected by the sucking operation.

In addition, since a predetermined number of through holes 27 is formed throughout the entire circumferential surface of the suction wheel outer cylinder 26, it is possible to continuously hold the transfer target object 8 by suction during the sucking operation even when the suction wheel outer cylinder 26 rotates in synchronization with the movement of the transfer target object 8 and the intermediary image transfer belt 4. Moreover, since air is continuously taken in through the concavity 23 that faces the transfer target object 8 during the sucking operation and has a small capacity and through the suction port 24, it is possible to ensure that a suction force applied to the transfer target object 8 is large enough to separate the transfer target object 8 from the intermediary image transfer belt 4. Therefore, the capacity of the vacuuming apparatus can be reduced. Furthermore, since the holding of the transfer target object 8 by suction is released when the hole of the suction wheel outer cylinder 26 is displaced from the position of the concavity 23, and thus from the suction port 24, it is possible to move the transfer target object 8 onto the next transport position smoothly.

In addition, since the nozzle 25 through which the front edge part of the transfer target object 8 is sucked also rotates when the suction wheel outer cylinder 26 rotates, it is possible to guide the front edge part of the transfer target object 8 to the position of the transfer target object belt transportation device 16 while securely holding the front edge part of the transfer target object 8 by suction. Since the front edge part of the transfer target object 8 is reliably sucked through the rotating nozzle 25, it is possible to make the circumferential width W of the concavity 23 of the nozzle 25 further smaller (than that of the circumferential width of the concavity 23 of the foregoing example). By this means, the pressure loss of the suction wheel 18 can be reduced effectively, which makes it possible to reduce the size of the vacuum pump 34 and achieve cost reduction. Though a minor gap exists between the outer circumferential surface of the shaft 20 and the inner circumferential surface of the suction wheel 18 or between the outer circumferential surface of the nozzle 25 and the inner circumferential surface of the suction wheel 18, the gap does not have any significant influence on the pressure loss. Needless to say, however, it is preferable to make these gaps smaller as much as possible in order to reduce the pressure loss.

The structure/configuration of the image formation apparatus 1 according to the present embodiment of the invention is not limited to the foregoing example. It may be modified in various ways. For example, a filter may be provided inside the open end of the shaft 20 to trap toner particles (solid content) of a liquid developer and liquid carrier (oil) of the liquid developer that are entrained with air when the air is taken in by the vacuum pump 34. The filter prevents the toner particles (solid content) and the liquid carrier (oil) from taken into the vacuuming apparatus. Thus, it is possible to avoid the vacuuming apparatus from being stained due to the infiltration of the toner particles and the liquid carrier.

The suction wheel outer cylinder 26 may be provided as a movable member that can be brought into contact with the intermediary image transfer belt 4 and distanced from the intermediary image transfer belt 4. Specifically, the suction wheel outer cylinder 26 may be set in contact with the intermediary image transfer belt 4 during the transportation of the transfer target object 8 only. In such a structure, the suction wheel outer cylinder 26 is set away from the intermediary image transfer belt 4 when the transfer target object 8 is not being transported. With such a structure, it is possible to prevent foreign substances such as remaining toner, dust, or the like that are attached to the intermediary image transfer belt 4 from moving onto the outer circumferential surface of the suction wheel outer cylinder 26. Thus, it is possible to avoid the transfer target object 8 from becoming stained during the sucking of the transfer target object 8.

As another modification example, a cleaning member that is in contact with the outer circumferential surface of the suction wheel outer cylinder 26 may be provided. The cleaning member automatically removes foreign substances that are attached to the outer circumferential surface of the suction wheel outer cylinder 26 during the rotation of the suction wheel outer cylinder 26. Therefore, it is possible to ensure a reliable sucking operation that is free from the staining of the transfer target object 8 for a long time period.

As still another modification example, the image formation apparatus 1 may not be provided with the intermediary image transfer belt 4. For example, the invention is applicable to a modified image formation apparatus that transfers a toner image that is formed with the use of a liquid developer on each of the photosensitive members 3Y, 3M, 3C, and 3K, which is an example of a latent image carrier, directly onto the transfer target object 8 without the intermediary transfer thereof onto the intermediary image transfer belt 4. In such a modified image formation apparatus, a transfer target object separation device separates a transfer target object from the latent image carriers. Therefore, in this modified structure, the latent image carrier functions as the transfer target object movement member and the liquid developer image carrier according to an aspect of the invention. In addition, in the modified image formation apparatus, a set of backup rollers that applies pressure to a transfer target object so that the transfer target object is in contact with the latent image carriers (which corresponds to the aforementioned backup rollers 11Y, 11M, 11C, and 11K) is an example of a transferring member according to an aspect of the invention. The invention may be applied to a four-cycle image formation apparatus. The invention may be applied to a single-color image formation apparatus that uses a liquid developer of a single color.

A transfer target object separation apparatus according to an aspect of the invention is not limited to a device that is used for the separation of a transfer target object ejected from a transfer nip. For example, the transfer target object separation apparatus may be used for separating, from a fixation member, a transfer target object that is ejected from a fixation nip of a fixation apparatus. An example of the fixation member from which the transfer target object is separated is a fixation roller. The modified transfer target object separation apparatus is provided at a downstream neighboring position viewed from the exit end of the fixation nip. That is, the invention can be applied to various transfer target object separation apparatuses for separating a transfer target object from a transfer target object transport device and various image formation apparatuses provided with such an transfer target object separation apparatus, which may be modified, altered, changed, adapted, and/or improved within a range not departing from the gist and/or spirit of the invention apprehended by a person skilled in the art from explicit and implicit description made herein. Such a modification, alteration, change, adaptation, and/or improvement is also encompassed in the scope of the appended claims.

What is claimed is:

1. A transfer target object separation apparatus comprising:
a transfer target object movement member that moves a transfer target object while in contact with a first surface of the transfer target object; and
a transfer target object separation suction section that sucks a second surface of the transfer target object opposite the first surface to separate the transfer target object from the transfer target object movement member, the transfer target object separation suction section including
a first cylindrical rotation member that has a suction inlet, and
a second cylindrical rotation member that is fitted on the first cylindrical rotation member and has a hole through which the second surface of the transfer target object is sucked.

2. The transfer target object separation apparatus according to claim 1, further comprising a vacuuming section that sucks air through the hole of the second cylindrical rotation member.

3. The transfer target object separation apparatus according to claim 1, wherein the first cylindrical rotation member rotates; and the second cylindrical rotation member rotates independently of the first cylindrical rotation member.

4. A transferring apparatus comprising:
a transferring member that causes a transfer target object to move in contact with an image carrier so as to transfer an image carried on the image carrier onto a first surface of the transfer target object; and
a transfer target object separation suction section that sucks a second surface of the transfer target object opposite the first surface to separate the transfer target object from the image carrier, the transfer target object separation suction section including
a first cylindrical rotation member that has a suction inlet, and
a second cylindrical rotation member that is fitted on the first cylindrical rotation member and has a hole through which the second surface of the transfer target object is sucked.

5. The transferring apparatus according to claim 4, further comprising a vacuuming section that sucks air through the hole of the second cylindrical rotation member.

6. The transferring apparatus according to claim 4, wherein the first cylindrical rotation member rotates; and the second cylindrical rotation member rotates independently of the first cylindrical rotation member.

7. An image formation apparatus comprising:
a latent image carrier that carries a latent image;
a developing section that develops the latent image with the use of a liquid developer to form an image on the latent image carrier;
a transfer medium onto which the image is transferred;
a first transferring section that transfers the image formed on the latent image carrier onto the transfer medium;
a second transferring section that transfers the image transferred to the transfer medium onto a first surface of a transfer target object; and
a transfer target object separation suction section that sucks a second surface of the transfer target object opposite the first surface to separate the transfer target object from the transfer medium, the transfer target object separation suction section including
a first cylindrical rotation member that has a suction inlet, and
a second cylindrical rotation member that is fitted on the first cylindrical rotation member and has a hole through which the second surface of the transfer target object is sucked.

8. A transfer target object separation control method comprising:
moving a suction inlet of a first cylindrical rotation member to a standby position;
rotating a second cylindrical rotation member that has a hole through which a transfer target object is sucked;
rotating the first cylindrical rotation member to move the suction inlet to a suction position;
evacuating air from the first cylindrical rotation member to suck the transfer target object through the suction inlet of the first cylindrical rotation member and a hole of the second cylindrical rotation member;
rotating the first cylindrical rotation member and the second cylindrical rotation member with the transfer target object being in a sucked state;
stopping the rotation of the first cylindrical rotation member when the suction inlet of the first cylindrical rotation member arrives at a suction release position; and
stopping the rotation of the second cylindrical rotation member when the hole of the second cylindrical rotation member through which the transfer target object is sucked arrives at a position at which suction through the suction inlet of the first cylindrical rotation member is not performed.
